(19) United States
(12) Patent Application Publication
(10) Pub. No.: US 2020/0125167 A1
(43) Pub. Date: Apr. 23, 2020

(54) Eye/Gaze Tracking System and Method

(71) Applicant: Tobii AB, Danderyd (SE)

(72) Inventors: Anders Dahl, Danderyd (SE); Oscar Mattias Danielsson, Danderyd (SE)

(73) Assignee: Tobii AB, Danderyd (SE)

(21) Appl. No.: 16/474,724

(22) PCT Filed: Dec. 30, 2016
(86) PCT No.: PCT/EP2016/082929

§ 371 Date: Jun. 28, 2019

(51) Int. Cl. G06F 3/01; G02B 27/00; G06K 9/00; H04N 13/383

(52) U.S. Cl. CPC G06F 3/013; H04N 13/383; G06K 9/00973; G02B 27/0093

(57) ABSTRACT

An eye/gaze tracking system (100) receives first and second image streams (D_{IMG1}, D_{IMG2}) in first and second processing lines (110; 120) respectively. The first processing line (110) has at least one first processor (P1, P11, P12) generating a first set of components of eye-specific data (p_{1LG}, p_{1LP}, p_{1RG}, p_{1RP}) for producing eye/gaze data (D_{E/G}). The second processing line (120) has at least one second processor (P2, P21, P22) generating a second set of components of eye-specific data (p_{2LG}, p_{2LP}, p_{2RG}, p_{2RP}) for producing the eye/gaze data (D_{E/G}). The eye/gaze data (D_{E/G}) describe an eye position and/or a gaze point of the subject (U).

### BACKGROUND

The present invention relates generally to solutions for determining a subject's eye positions and/or gaze point. More particularly the invention relates to an eye/gaze tracking system according to the preamble of claim 1 and a corresponding method. The invention also relates to a computer program and a non-volatile data carrier.

There are numerous fields of use for eye/gaze trackers. For example in disability aids, physiological and psychological research, consumer products, virtual-reality applications, the automotive industry, avionics and computer gaming. For accuracy and quality reasons it is generally preferred that a subject's eye positions and/or gaze point can be determined as precisely as possible and that the acquired data is updated at high frequency, or at least as often as is required by the implementation in question. Using stereo or 3D (three-dimensional) technology is one way to improve the accuracy of an eye/gaze tracker. Namely, 3D image data enables accurate measuring of distances to the subject and his/her eyes. Especially, based on 3D image data, important features of the subject's eye biometrics can be determined, e.g. the corneal curvature, which, in turn, provides important information to the tracking algorithms. Below follows a few examples of solutions using stereoscopic image registration.

WO 2015/143073 describes an eye tracking system with an image display configured to show an image of a surgical field to a user. The image display is configured to emit a light in first wavelength range. The system also includes a right eye tracker configured to emit light in a second wavelength range and to measure data about a first gaze point of a right eye of the user. The system further contains a left eye tracker configured to emit light in the second wavelength range and to measure data about a second gaze point of a left eye of the user. Additionally, an optical assembly is disposed between the image display and the right and left eyes of user. The optical assembly is configured to direct the light of the first and second wavelength ranges such that the first and second wavelengths share at least a portion of a left optical path between left eye and the image display and share at least a portion of a right optical path between the right eye and the image display, without the right and left eye trackers being visible to the user. The system further comprises at least one processor configured to process the data about the first gaze point and the second gaze point to determine a viewing location in the displayed image at which the gaze point of the user is directed.

U.S. Pat. No. 8,824,779 discloses a single lens stereo optics design with a stepped mirror system for tracking the eye, isolates landmark features in the separate images, locates the pupil in the eye, matches landmarks to a template centered on the pupil, mathematically traces refracted rays back from the matched image points through the cornea to the inner structure, and locates these structures from the intersection of the rays for the separate stereo views. Having located in this way structures of the eye in the coordinate system of the optical unit, the invention computes the optical axes and from that the line of sight and the torsion roll in vision. Along with providing a wider field of view, this invention has an additional advantage since the stereo images tend to be offset from each other and for this reason the reconstructed pupil is more accurately aligned and centered.

U.S. Pat. No. 7,747,068 reveals systems and methods for tracking the eye. In one embodiment, a method for tracking the eye includes acquiring stereo images of the eye using multiple sensors, isolating internal features of the eye in the stereo images acquired from the multiple sensors, and determining an eye gaze direction relative to the isolated internal features.

EP 2 774 380 describes a solution for determining stereo gaze tracking estimates a 3D gaze point by projecting determined right and left eye gaze points on left and right stereo images.

The determined right and left eye gaze points are based on one or more tracked eye gaze points, estimates for non-tracked eye gaze points based upon the tracked gaze points and image matching in the left and right stereo images, and confidence scores indicative of the reliability of the tracked gaze points and/or the image matching.

At least some of the above solutions may be capable of providing a better accuracy in terms of positioning the eyes and/or the gaze-point than an equivalent mono type of eye/gaze tracker. However, since a stereo system produces substantial amounts of image data, limitations in processing capacity may lead to difficulties in attaining a sufficiently high sampling frequency to capture quick eye movements, e.g. saccades.

### SUMMARY

The object of the present invention is therefore to offer a solution which both is capable of registering high-quality stereoscopic images and capturing quick eye movements.

According to one aspect of the invention, the object is achieved by the initially described arrangement; wherein, the input data contains first and second image streams. The data processing unit further contains first and second processing lines. The first processing line includes at least one first processor. The first processing line is configured to receive the first image stream, and based thereon; derive a first set of components of eye-specific data for producing output eye/gaze data. Analogously, the second processing line includes at least one second processor. The second processing line is configured to receive the second image stream, and based thereon; derive a second set of components of eye-specific data for producing the output eye/gaze data.

This system is advantageous because the two processing lines render it possible to operate at the same sampling frequency as in a mono system given a particular processing capacity per unit time. Thus, high positioning accuracy can be combined with high sampling frequency.

Preferably, therefore, the eye/gaze data contains a repeatedly updated eye position and/or a repeatedly updated gaze point of each of the at least one subject.

According to one embodiment of this aspect of the invention, the eye/gaze tracking system further comprises at least one output interface configured to output the eye/gaze data. Thereby, this data can be used in external devices, e.g. for measurement and/or control purposes.

According to another embodiment of this aspect of the invention, the first image stream depicts the scene from a first view angle and the second image stream depicts the scene from a second view angle different from the first view angle. Hence, stereoscopic imaging of the subject and his/her eye(s) is ensured.

According to an additional embodiment of this aspect of the invention, each of the first and second processing lines includes a primary processor configured to receive the first and second image streams respectively, and based thereon produce pre-processed data. This may involve determining whether there is an image of an eye included in the first and second image streams. The pre-processed data, in turn, form a basis for determining the first and second sets of components of eye-specific data. For example, the pre-processed data may contain a re-scaling of the first and second image streams respectively, result data of a pattern-recognition algorithm and/or result data of a classification algorithm. Thus, the subsequent data processing can be made highly efficient.

According to another embodiment of this aspect of the invention, each of the first and second processing lines contains at least one succeeding processor configured to receive the pre-processed data, and based thereon produce the first and second sets of components of eye-specific data. Thereby, the first and second sets of components of eye-specific data may describe a position for at least one glint and/or a position for at least one pupil of the at least one subject. Consequently, the key parameters for eye/gaze tracking are provided. Preferably, the glint detection and the pupil detection are executed in sequence. Alternatively, the processing scheme may involve parallel processing.

According to yet another embodiment of this aspect of the invention, the at least one succeeding processor is further configured to match at least one of the at least one glint with at least one of the at least one pupil. Thus, a reliable basis for performing eye/gaze tracking is offered.

According to still another embodiment of this aspect of the invention, the data processing unit also contains at least one post processor that is configured to receive the first and second sets of components of eye-specific data. Based on the first and second sets of components of eye-specific data, the at least one post processor, in turn, is configured to derive the eye/gaze data being output from the system. Hence, information from the two image streams is merged to form a high-quality output of eye/gaze data.

According to further embodiments of this aspect of the invention, the first and second processing lines are configured to process the first and second image streams temporally parallel, at least partially. As a result, relatively high sampling rates and updating frequencies can be implemented for a given processor capacity.

According to another aspect of the invention, the object is achieved by an eye/gaze tracking method involving: receiving, via at least one input interface input data representing stereoscopic images of a scene; and producing eye/gaze data describing an eye position and/or a gaze point of at least one subject. More precisely, the input data contains first and second image streams. Further, the method involves: receiving the first image stream in a first processing line containing at least one first processor; deriving, in the first processing line, a first set of components of eye-specific data for producing the output eye/gaze data; receiving the second image stream in a second processing line containing at least one second processor; and deriving, in the second processing line, a second set of components of eye-specific data for producing the output eye/gaze data. The advantages of this method, as well as the preferred embodiments thereof, are apparent from the discussion above with reference to the proposed system.

According to a further aspect of the invention the object is achieved by a computer program including instructions which, when executed on at least one processor, cause the at least one processor to carry out the method proposed above.

According to another aspect of the invention the object is achieved by a non-volatile data carrier containing the above-mentioned computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows an overview of a system according to one embodiment of the invention;

FIGS. 2-3 illustrate how first and second image sequences of a scene are registered according to embodiments of the invention; and

FIG. 4 illustrates, by means of a flow diagram, the general method according to the invention.

### DETAILED DESCRIPTION

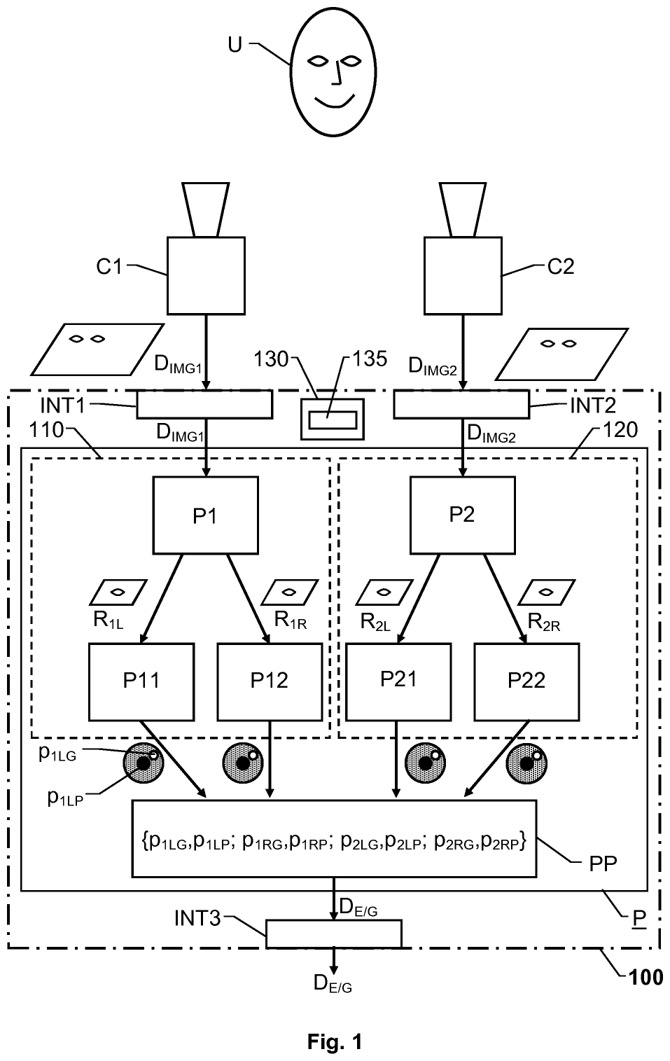

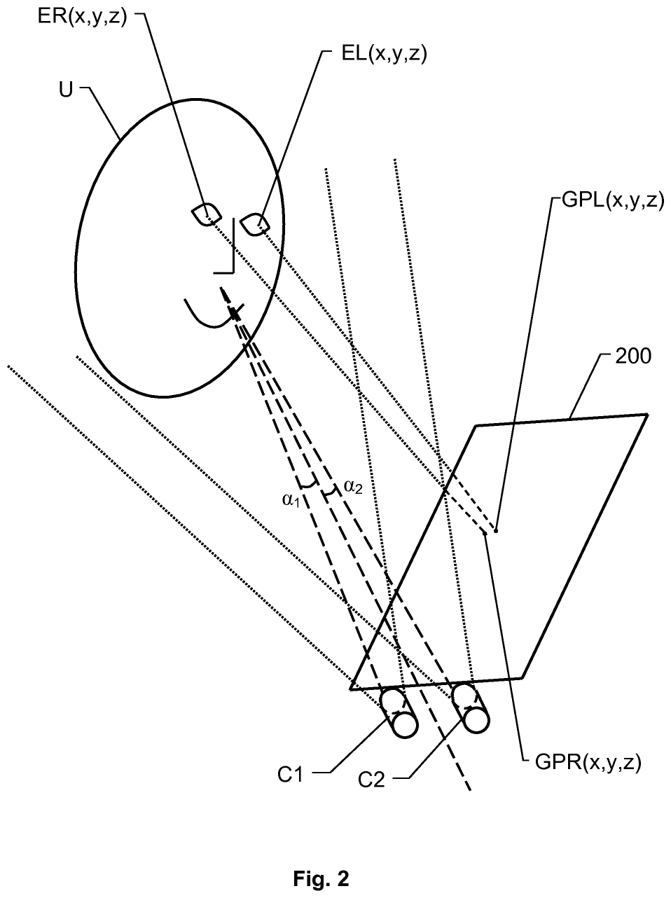

FIG. 1 shows an overview of an eye/gaze tracking system 100, and FIG. 2 illustrates how image data of a scene with a subject U is registered according to one embodiment of the invention.

The system 100 includes input interfaces INT1 and INT2 and a data processing unit P. The system 100 preferably also includes an output interface INT3. The input interfaces INT1 and INT2 are configured to receive input data in the form of first and second image streams D_{IMG1} and D_{IMG2} respectively. The first image stream D_{IMG1} may depict the scene from a first view angle α₁ as registered by a first camera C1, and the second image stream D_{IMG2} may depict the scene from a second view angle α₂ (different from the first view angle α₁) as registered by a second camera C2. Thus, together, the first and second image streams D_{IMG1} and D_{IMG2} represent stereoscopic images of the scene.

The data processing unit P, in turn, contains a number of processors P1, P11, P12, P2, P21, P22 and PP implementing first and second processing lines 110 and 120. A memory 130 in the data processing unit P contains instructions 135 executable by the processors therein, whereby the data processing unit P is operative to produce eye/gaze data D_{E/G} based the input data D_{IMG1} and D_{IMG2}.

The output interface INT3 is configured to output the eye/gaze data D_{E/G}. The eye/gaze data D_{E/G} describe an eye position for a right eye ER(x,y,z) and/or an eye position for a left eye EL(x,y,z) and/or a gaze point of the right eye GPR(x,y,z) and/or a gaze point of the left eye GPL(x,y,z) of the subject U, and or any other subject in the scene.

Preferably, the data processing unit P is configured to produce eye/gaze data D_{E/G} such that this data describe a repeated updates of the position for the right eye ER(x,y,z) and/or for the position for the left eye EL(x,y,z) and/or for the gaze point of the right eye GPR(x,y,z) and/or for the gaze point of the left eye GPL(x,y,z) of the subject U, and or for any other subject in the scene.

The first processing line 110 includes at least one first processor, here represented by P1, P11 and P12. The first processing line 110 is configured to receive the first image stream D_{IMG1}, and based thereon, derive a first set of components of eye-specific data p_{1LG}, p_{1LP}, p_{1RG} and p_{1RP} for producing the output eye/gaze data D_{E/G}.

Similarly, the second processing line 120 includes at least one second processor, here represented by P2, P21 and P22. The second processing line 120 is configured to receive the second image stream D_{IMG2}, and based thereon, derive a second set of components of eye-specific data p_{2LG}, p_{2LP}, p_{2RG} and p_{2RP} for producing the output eye/gaze data D_{E/G}.

According to embodiments of the invention, the processors P1, P11, P12, P2, P21, P22 and PP may be implemented by central processing units (CPUs), image processing units (IPUs), vision processing units (VPUs), graphics processing units (GPUs), application specific integrated circuit (ASICs) and/or field-programmable gate arrays (FPGAs) as well as any combinations thereof. Moreover, the processors P1, P11, P12, P2, P21, P22 and PP may be implemented by means of parallel image-processing lines of a streaming image pipeline system with embedded memory.

In one embodiment of the invention, the first processing line 110 contains a primary processor P1 configured to receive the first image stream D_{IMG1}, and based thereon, produce pre-processed data R_{1L} and R_{1R} forming a basis for determining the first set of components of eye-specific data p_{1LG}, p_{1LP}, p_{1RG} and p_{1RP}. Here, the pre-processed data R_{1L} and R_{1R} may include a re-scaling of the first image stream D_{IMG1}, result data of a pattern-recognition algorithm and/or result data of a classification algorithm. The re-scaling may involve size-reduction of one or more portions of the input data in the first image stream D_{IMG1} in order to decrease the amount of data in the continued processing. The pattern-recognition algorithm is typically adapted to find image data representing a human eye and the classification algorithm may be arranged to determine if the subject U wears glasses, whether or not an image of an eye is included in the data, whether or not the eye is open, and/or to which degree the eye lid covers the eye ball. Especially, the pre-processed data R_{1L} and R_{1R} may define a first region of interest (ROI) R_{1L} containing image data representing a left eye of the subject U and a second ROI R_{1R} containing image data representing a right eye of the subject U.

Analogously, the second processing line 120 may contain a primary processor P2 configured to receive the second image stream D_{IMG2}, and based thereon, produce pre-processed data R_{2L} and R_{2R} forming a basis for determining the second set of components of eye-specific data p_{2LG}, p_{2LP}, p_{2RG} and p_{2RP}. Here, the pre-processed data R_{2L} and R_{2R} may include a re-scaling of the first image stream D_{IMG1}, result data of a pattern-recognition algorithm and/or result data of a classification algorithm. The re-scaling may involve size-reduction of one or more portions of the input data in the second image stream D_{IMG2} in order to decrease the amount of data in the continued processing. The pattern-recognition algorithm is typically adapted to find image data representing a human eye and the classification algorithm may be arranged to determine if the subject U wears glasses, whether or not the eye is open, and/or to which degree the eye lid covers the eye ball. Especially, the pre-processed data R_{1L} and R_{1R} may define a third ROI R_{2L} containing image data representing the left eye of the subject U and a fourth ROI R_{2R} containing image data representing the right eye of the subject U.

According to one embodiment of the invention, the first processing line 110 also contains at least one succeeding processor, here exemplified by P11 and P12 respectively. A first succeeding processor P11 is configured to receive the pre-processed data R_{1L} and based thereon produce the first set of components of eye-specific data p_{1LG} and p_{1LP}. The first set of components of eye-specific data p_{1LG} and p_{1LP}, in turn, may describe a respective position for one or more glints in the left eye p_{1LG} and a position for the left-eye pupil p_{1LP}. A second succeeding processor P12 is configured to receive the pre-processed data R_{1R} and based thereon produce first set of components of eye-specific data in the form of p_{1RG} and p_{1RP}. The first set of components of eye-specific data p_{1RG} and p_{1RP}, in turn, may describe a respective position for one or more glints in the right eye p_{1RG} and a position for the right-eye pupil p_{1RP}.

Analogously, the second processing line 120 may contain at least one succeeding processor in the form of P21 and P22 respectively. A third succeeding processor P21 is here configured to receive the pre-processed data R_{2L} and based thereon produce second set of components of eye-specific data in the form of p_{2LG} and p_{2LP}. The second set of components of eye-specific data p_{2LG} and p_{2LP}, in turn, may describe a respective position for one or more glints in the left eye p_{2LG} and a position for the left-eye pupil p_{2LP}. A fourth succeeding processor P22 is here configured to receive the pre-processed data R_{2R} and based thereon produce second set of components of eye-specific data in the form of p_{2RG} and p_{2RP}. The second set of components of eye-specific data p_{2RG} and p_{2RP}, in turn, may describe a respective position for one or more glints in the right eye p_{2RG} and a position for the right-eye pupil p_{2RP}.

Furthermore, the succeeding processors P11, P12, P21 and P22 are preferably further configured to match at least one of the at least one glint with at least one of the at least one pupil, i.e. such that the glint positions and pupil positions are appropriately associated to one another. In other words, a common identifier is assigned to the glint(s) and the pupil that belong to the same eye of the subject U.

According to one embodiment of the invention, the data processing unit P also contains a post processor PP configured to receive the first and second sets of components of eye-specific data p_{1LG}, p_{1LP}, p_{1RG}, p_{1RP}, p_{2LG}, p_{2LP}, p_{2RG} and p_{2RP}, and based thereon derive the eye/gaze data D_{E/G}. Inter alia, the post processor PP may be configured to produce result data of a ray-tracing algorithm. The ray-tracing algorithm, in turn, may be arranged to determine and compensate for light deflection caused by any glasses worn by the subject U. As such, the post processor PP may either be regarded as a component included in both the first and second processing lines 110 and 120, or as a component outside the first and second processing lines 110 and 120.

In any case, it is highly preferably if the first and second processing lines 110 and 120 are configured to process the first and second image streams D_{IMG1} and D_{IMG2} temporally parallel, at least partially. For example the processors P1, P11 and P12 may process input data in the first image stream D_{IMG1}, which input data has been registered during a given period at the same time as the processors P2, P21 and P22 process input data in the second image streams D_{IMG2}, which input data also has been registered during the given period.

Basically, it is advantageous if the eye/gaze tracking system 100 is arranged to operate in two different modes, for example referred to as an initial recovery mode and a subsequent ROI mode.

In the recovery mode, the primary processors P1 and P2 operate on full frame data to identify eyes in the first and second image streams D_{IMG1} and D_{IMG2} respectively, and to localize the eyes' positions. Then, when at least one eye of the subject U has been identified and localized, the ROI mode is activated. In this phase, the succeeding processors P11, P12, P21 and P22 operate on sub-frame data (typically represented by ROIs) to track each identified eye. Ideally, the eye/gaze tracking system 100 stays in the ROI mode until: (a) tracking is lost, or (b) the eye/gaze tracking is stopped. In the case of tracking loss, the eye/gaze tracking system 100 re-enters the recovery mode in order to identify and localize the subject's eyes again.

FIG. 3 illustrates how image data of a scene with a subject U is registered according to another embodiment of the invention. Here, the first and second cameras C1 and C2 form part of a virtual-reality (VR) and/or augmented-reality (AR) system 310 that is mounted on the head of the subject U. For example, the first and second cameras C1 and C2 may be arranged to determine an eye position ER(x,y,z) of a single eye of the subject U, say his/her right eye with relatively high accuracy and relatively high updating frequency. Analogous to the embodiment shown in FIG. 2, the first camera C1 registers a first image stream D_{IMG1} depicting the scene from a first view angle α₁, and the second camera C2 registers a second image stream D_{IMG2} depicting the scene from a second view angle α₂ being different from the first view angle α₁. Together, the first and second image streams D_{IMG1} and D_{IMG2} thus represent stereoscopic images of the scene, i.e., here containing the subject's U right eye. This enables highly accurate tracking of the subject's eye and/or gaze.

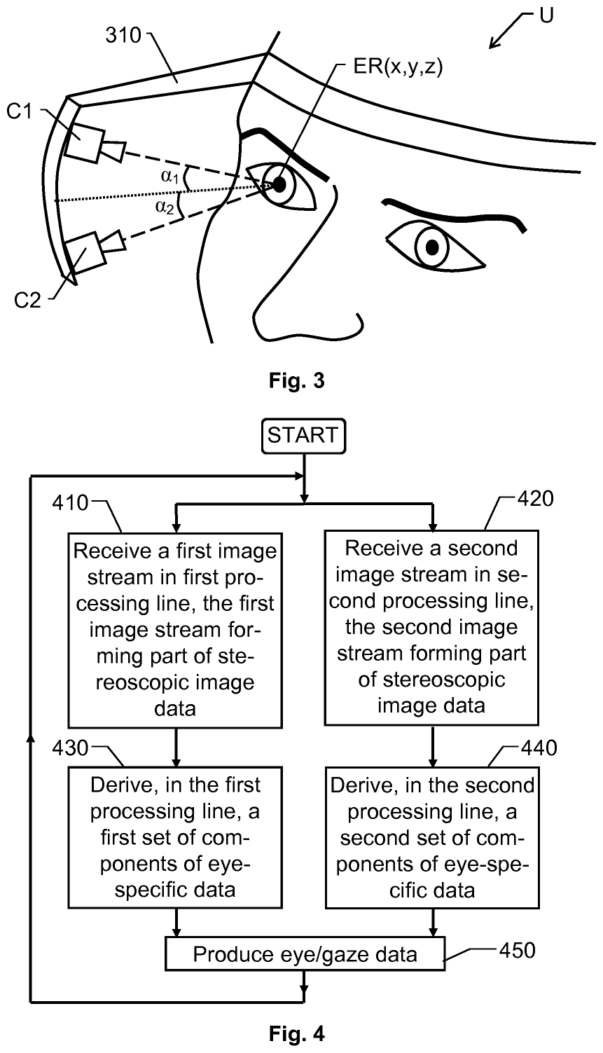

In order to sum up, and with reference to the flow diagram in FIG. 4, we will now describe the general method according to the invention for eye/gaze tracking.

In a first step 410, a first image stream is received in a first processing line that contains at least one first processor. The first image stream is received via a first input interface and forms part of stereoscopic images of a scene that is presumed to contain at least one subject.

Analogously, in a second step 420, preferably executed in parallel with step 410, a second image stream is received in a second processing line containing at least one second processor. The second image stream may either be received via the same interface as the first image stream, or via a separate interface. In any case, the second image stream forms part of stereoscopic images of the scene and is presumed to contain a representation of the at least one subject, however recorded from a slightly different angle than the first image stream.

A step 430, subsequent to step 410 in the first processing line, derives a first set of components of eye-specific data for producing output eye/gaze data. For example, the first set of components of eye-specific data may include respective definitions of first and second regions of interest containing image data representing first and second eyes of the at least one subject.

Analogously, a step 440, subsequent to step 420 in the second processing line, derives a second set of components of eye-specific data for producing output eye/gaze data. The second set of components of eye-specific data may also include respective definitions of first and second regions of interest containing image data representing first and second eyes of the at least one subject.

After steps 430 and 440, a step 450 produces eye/gaze data based on the first and second sets of components of eye-specific data. The eye/gaze data describes an eye position and/or a gaze position for the at least one subject. Subsequently, the procedure loops back to steps 410 and 420 for receiving updated data in the first and second image streams, so that eye/gaze data can be updated.

The frequency at which the procedure runs through steps 410 to 440 and loops back from step 450 to steps 410 and 420 preferably lies in the order of 60 Hz to 1.200 Hz, and more preferably in the order of 120 Hz to 600 Hz.

All of the process steps, as well as any sub-sequence of steps, described with reference to FIG. 4 above may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

It should be noted that the eye/gaze tracking system as described in the embodiments of the present application may form part of a virtual-reality or augmented reality apparatus with eye/gaze tracking functionality, or be included in a remote eye tracker communicatively coupled to a display or a computing apparatus (e.g. laptop or computer monitor or etc.), or be included in a mobile device (e.g. smartphone). Moreover, the proposed eye/gaze tracking system may be implemented in the cabin of a vehicle/craft for gaze detection and/or tracking of a driver or a passenger in the vehicle/craft.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1.-22. (canceled)

23. An eye/gaze tracking system, comprising:
at least one input interface configured to receive input data representing stereoscopic images of a scene, and
a data processing unit containing:
at least one processor, and
at least one memory, which at least one memory contains instructions executable by the at least one processor,
whereby the data processing unit is operative to, based on the input data, produce eye/gaze data describing at least one of: an eye position and a gaze point of at least one subject, characterized in that the input data comprises first and second image streams; and
a first processing line with at least one first processor, the first processing line being configured to receive the first image stream, and based thereon, derive a first set of components of eye specific data for producing the output eye/gaze data, and
a second processing line with at least one second processor, the second processing line being configured to receive the second image stream, and based thereon, derive a second set of components of eye-specific data for producing the output eye/gaze data.

24. The eye/gaze tracking system according to claim 1, further comprising at least one output interface configured to output the eye/gaze data.

25. The eye/gaze tracking system according to claim 1, wherein the eye/gaze data comprises a repeatedly updated eye position and a repeatedly updated gaze point of each of the at least one subject.

26. The eye/gaze tracking system according to claim 1, wherein the first image stream depicts the scene from a first view angle and the second image stream depicts the scene from a second view angle different from the first view angle.

27. The eye/gaze tracking system according to claim 1, wherein each of the first and second processing lines comprises:
a primary processor configured to receive the first and second image streams respectively, and based thereon produce pre-processed data forming a basis for determining the first and second sets of components of eye-specific data.

28. The eye/gaze tracking system according to claim 27, wherein the pre-processed data comprises at least one of: a re-scaling of the first and second image stream respectively, result data of a pattern-recognition algorithm and result data of a classification algorithm.

29. The eye/gaze tracking system according to claim 27, wherein each of the first and second processing lines comprises:
at least one succeeding processor configured to receive the pre-processed data, and based thereon produce the first and second sets of components of eye-specific data so as to describe at least one of: a position for at least one glint, and a position for at least one pupil of the at least one subject.

30. The eye/gaze tracking system according to claim 29, wherein the at least one succeeding processor is further configured to match at least one of the at least one glint with at least one of the at least one pupil.

31. The eye/gaze tracking system according to claim 29, wherein the data processing unit contains at least one post processor configured to receive the first and second sets of components of eye-specific data, and based thereon derive said eye/gaze data.

32. The eye/gaze tracking system according to claim 1, wherein the first and second processing lines are configured to process the first and second image streams temporally parallel.

33. An eye/gaze tracking method comprising:
receiving, via at least one input interface input data representing stereoscopic images of a scene, and
producing eye/gaze data describing at least one of: an eye position and a gaze point of at least one subject, characterized by the input data comprising first and second image streams, and
receiving the first image stream in a first processing line comprising at least one first processor,
deriving, in the first processing line, a first set of components of eye-specific data for producing the output eye/gaze data,
receiving the second image stream in a second processing line comprising at least one second processor, and
deriving, in the second processing line, a second set of components of eye-specific data for producing the output eye/gaze data.

34. The method according to claim 33, comprising:
outputting the eye/gaze data via at least one output interface.

35. The method according to claim 33, wherein producing the eye/gaze data comprises:
updating, repeatedly, at least one of: the eye position and the gaze point of each of the at least one subject.

36. The method according to claim 33, wherein the first image stream depicts the scene from a first view angle and the second image stream depicts the scene from a second view angle different from the first view angle.

37. The method according to claim 33, comprising:
receiving the first and second image streams in a respective primary processor, and
producing, in the primary processors, respective pre-processed data forming a basis for determining the first and second sets of components of eye-specific data.

38. The method according to claim 37, wherein pre-processed data comprises at least one of: a re-scaling of the first and second image stream respectively, result data of a pattern-recognition algorithm and result data of a classification algorithm.

39. The method according to claim 37, wherein each of the first and second processing lines comprises at least one succeeding processor, and the method further comprises:
receiving the pre-processed data in the at least one succeeding processor, and
producing, in the at least one succeeding processor, the first and second sets of components of eye-specific data so as to describe at least one of: a position for at least one glint, and a position for at least one pupil of the at least one subject.

40. The method according to claim 39, further comprising:
matching, the at least one succeeding processor, at least one of the at least one glint with at least one of the at least one pupil.

41. The method according to claim 39, wherein the data processing unit contains at least one post processor, and the method comprises:
receiving the first and second sets of components of eye-specific data in the at least one post processor, and
deriving, in the at least one post processor, said eye/gaze data.

42. The method according to claim 33, comprising:
processing the first and second image streams temporally parallel.
